(19) United States
(12) Patent Application Publication
(10) Pub. No.: US 2005/0004236 A1
(43) Pub. Date: Jan. 6, 2005

(54) Method of preparing agglomerated silica

(76) Inventors: David P. Workman, Naperville, IL (US); Ronald S. Doles, LaGrange Park, IL (US)

Correspondence Address: Michael B. Martin;Patent & Licensing Department, Ondeo Nalco Company, Ondeo Nalco Center, Naperville, IL, 60563-1198, US

(21) Appl. No.: 10/610,687

(22) Filed: Jul. 1, 2003

(51) Int. Cl. C01B 33/141; B32B 21/12

(52) U.S. Cl. 516/80; 428/452

(57) ABSTRACT

Silica particle agglomerates prepared by adding an aluminum phosphate agglomerating agent with mixing to an aqueous dispersion of colloidal silica particles to form an aqueous homogeneous dispersion of silica particles and agglomerating agent and then adjusting the pH of the dispersion with mixing to about 3.5 to about 8.5 to produce the agglomerated silica particles and use of the agglomerates to prepare an ink receptive coating, as catalysts, as reinforcing fillers and as flattening agents.

### TECHNICAL FIELD

This invention is a method of preparing agglomerated silica particles having a controlled particle size and to use of the agglomerated silica particles, particularly in ink receptive coatings, as catalysts, as reinforcing fillers and as flattening agents.

### BACKGROUND OF THE INVENTION

Silica in its various forms is useful in multitudinous applications including, for example, as a catalyst support, as retention and drainage aids in papermaking, in surface coatings, as flattening agents, as proppants and as polishing abrasives, particularly in the electronics industry. The form of silica used in a particular application depends in large part on the silica particle's size and porosity characteristics.

Common forms of silica include colloidal silica, precipitated silica, silica aerogels and fumed silica. Colloidal silica consists of a suspension of usually discrete particles in a solvent with particle size ranging from 3 nm to 150 nm and little or no porosity. Precipitated silicas are dried particles with size ranging between 1 and 20 μm and surface area between 25 and 700 m²/g. Silica aerogels are dried particles with particle size from several microns to millimeters and surface area up to 800 m²/g. Fumed silica is an extremely small particle with surface area ranging from 100 to 400 m²/g with a tendency to form chains in the chemical manufacturing process.

In catalysis, silica is used as a catalytic support, or as a porous layer coated or impregnated on monolithic supports. Colloidal silica is used in the production of catalytic supports because of its excellent binding properties. It may be used separately or in conjunction with other materials such as but not limited to clays, alumina, silica gel and fumed silica.

Silica is used in paper as a retention and drainage aid and in coatings such as anti-skid, anti-block and ink receptive. In ink receptive coatings the coating pigment has specific porosity characteristics that are required in order to facilitate ink absorption. Colloidal silica is used as a retention and drainage aid and in anti-skid and anti-block applications. Silica gel and fumed silica are commonly used in numerous coating applications including ink receptive.

As filler, through surface interactions, silica reinforcement increases the strength and wear resistance of various materials including rubber and plastics, allowing them to be used in a wider number of applications in accordance with the user's exact requirements. Precipitated silica and fumed silica are used as fillers for this application.

As flattening agent, where inclusion of particles of sufficient size (greater than 300 nm) in coating formulation can result in increased roughness of finished coating. The increased roughness results in increased scattering of light and a reduction in the specular gloss of the surface. Fumed silica and precipitated silica are used a flattening agents in applications such as paints or automotive coatings.

Thus, for these and numerous other applications, it is necessary for the silica to have certain morphological characteristics, including particle size and porosity. Accordingly, there is an ongoing need for methods of selectively preparing silica particles having the desired agglomerate particle size and porosity in order to maximize performance of the silica particles in the desired application.

Silica/alumina composite particles prepared by mixing a silica sol and an acidic aluminum salt in an aqueous medium and a coating for an ink jet printing medium comprising the particles is disclosed in U.S. patent application Ser. No. 2002/0171730 A1.

### SUMMARY OF THE INVENTION

This invention is a method of preparing a silica particle agglomerate comprising
a) adding an aluminum phosphate agglomerating agent with mixing to an aqueous dispersion of colloidal silica particles to form an aqueous homogeneous dispersion of silica particles and agglomerating agent; and
b) adjusting the pH of the dispersion with mixing to about 3.5 to about 8.5 to agglomerate the silica particles.

The method of this invention permits the preparation of agglomerated silica particles having controlled size and porosity.

The silica particle agglomerate prepared as described herein is capable of forming a coating film or particle with controlled size and porosity which is suitable for applications including coatings for recording media, catalysis support, filler and as a flattening agent.

### DETAILED DESCRIPTION OF THE INVENTION

The production of agglomerated silica particles according to this invention is a two step process involving adding an agglomerating agent to an aqueous dispersion of silica particles and then inducing the agglomeration of the particles by adjusting the pH of the dispersion to about 3.5 to about 8.5. Control of the agglomerate particle size is accomplished through control of primary particle size, silica concentration, agglomerating agent concentration, and the method of pH adjustment as described herein.

As used herein, “silica sol” means a stable dispersion of alkaline or deionized colloidal silica particles in water. Typical particle sizes range from about 3 to about 120 nm. Silica sols are commercially available, for example from Ondeo Nalco Company, Naperville, Ill.

The production of deionized silica sols is known in the art. The deionized silica particles used to prepare the agglomerated silica in the process of this invention are prepared by deionizing an alkaline silica sol using strong acid cation and strong base anion resins such as those available from Dow Chemical Company, Midland, Mich. under the tradenames, Dowex 650C Dowex 550A

An aluminum phosphate agglomerating agent is then added to the dispersion of silica particles with mixing in an amount of about 5 to about 25 weight percent, based on dry weight of silica and agglomerating agent.

The pH of the dispersion is adjusted to about 3.5 to about 8.5, preferably about 4 to about 6 in order to agglomerate the silica particles. Suitable bases for the pH adjustment include hydroxides such as NaOH and KOH and amines and ammonium hydroxides of formula NR₄OH where R is H or C₁-C₄ alkyl or a mixture thereof. NaOH, KOH and NH₄OH are preferred.

Alternatively, the pH is adjusted by mixing the dispersion of silica particles and agglomerating agent with an aqueous pH aqueous buffer solution. For example, The dispersion of silica particles and agglomerating agent can be poured into an acetic acid/acetate buffer solution resulting in a final pH of 4.0-5.5.

The aqueous dispersion of agglomerated silica particles may then be concentrated to the desired concentration using, for example, ultrafiltration, evaporation, and centrifugation techniques.

The process of this invention is used to prepare submicron agglomerated silica particles having a controlled particle size.

The variables that have the largest impact on particle size are the primary particle size, silica concentration and aluminum phosphate agglomerating agent dosage. The method of pH adjustment indirectly impacts particle size by modifying the operational limits of silica concentration and agglomerating agent dosage. The concentration of silica ranges from about 2 percent to about 25 percent with satisfactory results depending upon the method of pH adjustment. Using NaOH or other alkali agent requires silica concentration in 2-8 percent range, while the buffer system will support higher silica concentrations.

In general, silica concentration can be reduced without detrimental effects. The particle size (d₅₀) of the agglomerated material may rapidly grow into the micron sized if the silica concentration is outside recommended values.

The amount of aluminum phosphate agglomerating agent added is based on the dry weight of silica and agglomerating agent. Dosage at 10 percent based on solids means if silica dry weight is 1 g then the dry weight of agglomerating agent is 0.1 g. The typical agglomerating agent dose is about 5 to about 25 percent based on solids. At the high end of the range particle size starts to grow dramatically into the micron range. Dosages lower than about 5 percent result in incomplete reaction and a distribution having a little agglomerated material and mostly unreacted starting sol. Reactions using a buffer system pH adjustment allow higher agglomerating agent dosages. Use of NaOH, limits the agglomerating agent dosage to about 5 percent to about 12 percent based on the silica dry weight.

Operation outside recommended ranges for silica concentration or aluminum phosphate agglomerating agent dosage result in the production of micron sized agglomerated material. The primary particle size has a direct impact on the agglomerated particle size. A primary particle at 150 nm will yield a larger agglomerate than a 60 nm primary particle.

The aluminum phosphate agglomerating agent for use in the process of this invention is the reaction product of aluminum hydroxide and hot phosphoric acid resulting in a covalently bonded composition that is soluble in phosphoric acid. The aluminum phosphate agglomerating agent generates an insoluble or slightly soluble metal hydroxide or metal phosphate species during the pH adjustment step described herein.

The aluminum phosphate agglomerating agent is preferably synthesized by heating a mixture of aluminum hydroxide, [Al(OH)₃] and with about 2.5 to about 6.0 molar equivalents of phosphoric acid at a temperature of about 50 to about 100° C., preferably about 90° C., for a sufficient amount of time for substantially all of the aluminum hydroxide to react, typically about 0.5 to about 4.0 hours. About 0.1 to about 0.5 molar equivalents of boric acid is added as a stabilizer. After the reaction is complete the aluminum phosphate reagent is diluted to the desired concentration, typically about 30 to about 70 percent based on the weight of aluminum phosphate solids.

In another aspect of this invention, a metal oxide coating of alumina, ceria or titania is applied to the agglomerated silica particles prepared as described herein. The metal oxide coating provides a cationic surface charge under appropriate pH conditions. The coatings are applied to a targeted coating thickness of 2-5 nm using technology currently employed for coating silica sols. The impact of the coating on agglomerate size is minimal.

In another aspect, this invention is an ink receptive media prepared by applying to a substrate a coating comprising agglomerated silica particles prepared as described herein. Representative substrates include cellulose paper, synthetic paper, non-woven fabrics, plastic films and resin-coated papers. Plastic films include polyester resin (such as polyethylene teraphthalate), polycarbonate resin, fluororesin, polyvinyl chloride resin, and the like. “Resin-coated paper” means papers having a polyolefin resin coating on the surface.

Ink jet applications utilize specialized coating on the printing substrate to improve a multitude of image quality issues. Porous coatings were developed in part to meet escalating print speed demands. The ink receptive coating utilizes capillary action to wick away the mobile phase of an ink jet droplet. Porosity in the coating (internal to the silica particles and due to packing density) allows rapid diffusion of ink into the coating structure while providing capacity for liquid uptake.

To prepare an ink receptive coating the agglomerated silica particles are formulated with a binder such as polyvinyl alcohol (PVA), starch, SBR latex, NBR latex, hydroxycellulose, polyvinyl pyrrolidone, and the like prior to application to a substrate such as paper. The agglomerated silica to binder ratio can be varied but is typically higher in agglomerated silica than binder.

The binder may also be cross-linked to improve the coating strength and reduce cracking. Preferred cross linking agents for PVA binders include boric acid and borates.

The coating is applied to the substrate using a bar coater, a gravure coater, an air knife coater, a blade coater, a curtain coater, and the like and then dried to prepare the ink-receptive coating.

Accordingly, in another aspect, this invention is a method of preparing ink jet printer media comprising applying agglomerated silica particles prepared as described herein to the surface of the paper or other suitable substrate.

In another aspect, this invention is a porous catalyst support comprising agglomerated silica particles prepared as described herein.

The catalyst support can be for fluidized or fixed bed applications. The support can be prepared by known methods but not limited to spray drying and extrusion. The support may then be impregnated with catalytic metals such as platinum, palladium, gold, rhodium, or molybendum. Additional metals can be used as required by the specific catalytic process and are obvious to those skilled in the art.

In another aspect, this invention is a filler comprising agglomerated silica particles prepared as described herein.

Silica has also been used a as a reinforcing filler for elastomeric compositions and injection molded thermoplastics. The silica filler is used to improve the mechanical properties of the basic polymer formulation. In tires, the addition of silica or “white filler” has provided improvements in rolling resistence and traction on snow when compared to convential tires filled with carbon black. Fumed silica and precipitated silica are used as reinforcing filler for rubber compositions. In the application the silica will be treated with a hydrophobizing agent and compounded with the elastomeric composition via mechanical mixing to disperse the silica evenly throughout formulation.

In another aspect, this invention is a flattening agent or gloss modifier comprising agglomerated silica prepared as described herein. Inclusion of particles exceeding 300 nm in coating formulation can result in a reduction in the gloss of the coated surface. These larger particles increase the roughness of the coating. As a result increased scattering of light occurs that reduces the specular gloss of the surface.

The foregoing may be better understood by reference to the following examples, which are presented for purposes of illustration and are not intended to limit the scope of this invention.

### EXAMPLE 1

Preparation of an Aluminum Phosphate Reagent.

Phosphoric acid (2538 g, of 75%) is placed in a reaction vessel and heated to 90° C. with stirring. Aluminum hydroxide (387 g) is added in small portions to the hot acid solution over 60 minutes. The reaction can be vigorous and may foam. After reaction of substantially all of the aluminum hydroxide (reaction mixture clear) boric acid (78 g) is added in small portions over 30 minutes. The reaction mixture is heated until the solution is clear (about 1 hour after addition of the boric acid). The reaction mixture is then cooled to ambient temperature and deionized water (1650 g) is added to provide a solution of the aluminum phosphate reagent (45% solids).

### EXAMPLE 2

Preparation of a Silica Particle Agglomerate Using NaOH.

Deionized silica sol (30% aqueous dispersion, 416.67 g), deionized water (2083 g) and aluminum phosphate reagent (27.78 g, prepared as in Example 1) are weighed into a reaction vessel. The reaction vessel is stirred at room temperature. The pH of the mixture is 2.17. Aqueous sodium hydroxide solution (1M, 112.5 g) is added over about 15 minutes. The final solution pH is 4.65.

### EXAMPLE 3

Preparation of Silica Particle Agglomerate Using a pH Buffer.

Deionized silica sol (30% aqueous dispersion, 625.0 g), deionized water (1250 g) and aluminum phosphate reagent (41.67 g, prepared as in Example 1) are weighed into a flask and mixed with stirring. A solution of sodium acetate (1 molar, 577.1 g) is weighed into a reaction vessel. The reaction vessel solution is stirred at room temperature. The silica/aluminum phosphate mixture is added to the sodium acetate solution over 45 minutes. The final solution pH is 5.01.

The agglomerated material prepared as described in Examples 2 and 3 can then be concentrated using ultrafilteration, evaporation, and centrifugation techniques. Samples concentrated to 50% solids are stable for at least two weeks in a 60° C. oven. This test roughly correlates with minimum 6 months stability at room temperature. The samples will settle with time but can be readily re-dispersed by agitation.

### EXAMPLE 4

Particle Size Determination.

Agglomerated particles size is characterized using a Horiba LA-300 laser scattering particle size distribution analyzer. Table II contains data for typical particle size distribution for a given primary particle size for agglomerated silica particles. Distributions provided are consistent with agglomerates prepared according to the method of Example 2 or Example 3. The particle distribution is calculated using volume basis. The instrument is capable of measuring particles from 100 nm to 600 microns.

TABLE 2
Agglomerate Particle Size Distribution Data

| Primary | Agglomerate Size | Agglomerate Size | Agglomerate Size |
|---|---|---|---|
| Particle (nm) | d₁₀(V) (nm) | d₅₀(V) (nm) | d₉₀(V) (nm) |
| 60 | 162 | 226 | 345 |
| 90 | 215 | 346 | 505 |
| 150 | 326 | 640 | 1083 |

### EXAMPLE 5

Preparation of an Ink Receptive Coating Containing Agglomerated Silica Particles.

To 500 g of agglomerated silica slurry (50% solids) prepared from 60 nm deionized silica particles according to the method of Example 2 is added with mixing polyvinylalcohol solution (206 g, 30% solids, Celvol 203S, available from Celanese Ltd.). The mixture is stirred for at least one hour.

The particle-binder mixture is then applied on paper to create an ink receptive coating. Hand drawndown coating is applied using a Mayer rod. A coat weight ladder is prepared by varying the Mayer rod used. The coated paper samples are dried and calendared using a Hot Soft Nip calendar. A test pattern is printed on the coated paper and the print characteristics are analyzed. The results are shown in Table 3.

TABLE 3
Data on coated samples

| | Silica/Alumina | |
|---|---|---|
| | Agglomerate | Fumed Silica |
| Pigment:Binder Ratio | 80:20 | 80:20 |
| Black Ink Density | 2.0 | 1.9 |
| Gloss (75 deg) | 70 | 54 |
| Pore Diameter (nm) | 10-30 | 15-70 |
| Solids (%) | 44.6 | 27.6 |
| Viscosity (cps) | 670 | 600 |

As shown in Table 3, good specular gloss and black ink density values were obtained with the agglomerated material. Gloss values are above fumed silica values that is used in commercial inkjet papers. The high ink density values indicate that the ink is retained at the surface and is not wicked into the interior of the coating. Higher coating solids are achieved with the agglomerated material at comparable viscosity. The higher solids will aid processing, dry time, of coated substrates.

Additional experiments demonstrated that high pigment/binder ratios (12:1) were achieved without the presence of dusting while maintaining the high ink density. Dusting is a flaking of the coating that reduces the print quality of the paper and often results in particles that lodge in the paper rolls and jamming the equipment. A high pigment/binder ratio is favorable; a low ratio can impact drying time and limit processing.

Changes can be made in the composition, operation and arrangement of the method of the invention described herein without departing from the concept and scope of the invention as defined in the claims.

1. A method of preparing a silica particle agglomerate comprising
a) adding an aluminum phosphate agglomerating agent with mixing to an aqueous dispersion of colloidal silica particles to form an aqueous homogeneous dispersion of silica particles and agglomerating agent; and
b) adjusting the pH of the dispersion with mixing to about 3.5 to about 8.5 to agglomerate the silica particles.

2. The method of claim 1 wherein the colloidal silica particles have a particle size of about 3 nm to about 150 nm as measured by quasi elastic light scattering.

3. The method of claim 1 wherein the agglomerated silica particles have a median, d50(V), particle size of about 150 nm to about 900 nm as measured by laser light scattering.

4. The method of claim 1 wherein the pH is adjusted to about 4 to about 6.

5. The method of claim 4 wherein the pH is adjusted using aqueous sodium hydroxide, aqueous potassium hydroxide or aqueous ammonium hydroxide.

6. The method of claim 4 wherein the pH is adjusted by mixing the dispersion of silica particles and agglomerating agent with an aqueous pH buffer solution.

7. The method of claim 1 further comprising applying a metal oxide coating such as alumina, ceria or titania coating to the agglomerated silica particle.

8. An ink-receptive coating for a substrate comprising agglomerated silica particles prepared according to the method of claim 1.

9. Paper for use in an ink printing device comprising paper and agglomerated silica particles prepared according to the method of claim 1 applied to the surface of the paper.

10. A method of preparing ink jet printer paper comprising applying agglomerated silica particles prepared according to the method of claim 1 to the surface of the paper.

11. A catalyst support comprising agglomerated silica particles prepared according to the method of claim 1.

12. A reinforcing filler composition comprising agglomerated silica particles prepared according to the method of claim 1.

13. A flattening agent comprising agglomerated silica particles prepared according to the method of claim 1.
